(19) United States
(12) Patent Application Publication
(10) Pub. No.: US 2025/0385501 A1
(43) Pub. Date: Dec. 18, 2025

(54) IMPROVEMENTS IN AND RELATING TO MOUNT ASSEMBLIES

(71) Applicant: ZEST ECO LTD, Leeds, Yorkshire (GB)

(72) Inventors: Robin HEAP, Leeds, Yorkshire (GB); Luke FLETCHER, Leeds, Yorkshire (GB); Andy BUTLER, Leeds, Yorkshire (GB); Dan HARRIS, Leeds, Yorkshire (GB)

(21) Appl. No.: 19/130,261

(22) PCT Filed: Nov. 14, 2023
(86) PCT No.: PCT/GB2023/052984

§ 371 Date: May 15, 2025

(30) Foreign Application Priority Data
Nov. 17, 2022 (GB) 2217188.8

(51) Int. Cl. H02G 9/06; B60L 53/31; H02G 3/04

(52) U.S. Cl. CPC H02G 9/06; B60L 53/31; H02G 3/0493

(57) ABSTRACT

According to the present disclosure there is provided a mount assembly for mounting a structure thereto, comprising: a mount comprising; a conduit for routing electrical cables therethrough; and a frame surrounding the conduit for supporting a cover. Also disclosed is a method of installing a mount assembly for mounting a structure thereto, comprising, in an installation volume; providing a mount comprising a conduit for routing electrical cables therethrough and a frame surrounding the conduit for supporting a cover.

### FIELD

The present disclosure relates to a mount assembly, in particular a mount assembly for mounting a structure thereto. The present disclosure also relates to a method of installing a mount assembly for mounting a structure thereto. The present disclosure also relates to an assembly comprising a structure and a mount assembly. The present disclosure also relates to kits of parts.

### BACKGROUND TO THE INVENTION

In many circumstances it is desired to secure a structure to the ground. It is known to mount the structure on a mount assembly which is installed in the ground. Such mount assemblies may otherwise be referred to as a ground mounting system, foundation, or foundation system. It is also commonly required to provide the structure with an electrical connection, for power, communications, or other purposes.

In installation of the mount assembly a conduit is positioned in a volume excavated in the ground. Electrical cables are routed through the conduit. Concrete is introduced into the volume surrounding the conduit. The concrete is then covered or shielded, for example using barriers, in an ad-hoc manner to allow the concrete to set without interference or disruption by site workers or members of the public. The conduit remains protruding from the setting concrete, and thus presents a trip hazard.

Subsequently, it is necessary to return to the installation to form the completed mount assembly. The conduit must be cut flush with ground level, a number of fixing holes drilled into the concrete around the conduit, and a chemical anchor inserted into the fixing holes to install fixing bolts in the fixing holes. The fixing bolts protrude from the ground surface, again presenting a trip hazard, until a structure is mounted on the fixing bolts.

It is notable that civil works and electrical works are rarely completed simultaneously. Thus, the fixing bolts and possibly also the electrical cables may remain exposed for a considerable length of time, presenting a risk to pedestrians in the vicinity and a risk of damage to the mount assembly and cables.

One known approach which reduces trip hazard requires installation of a socket in the excavation volume after which concrete is introduced into the volume surrounding the socket and left to set to secure the socket in-place. When it is desired to mount the structure, a plate can be connected to the socket and the structure mounted to the plate. However, this approach fails to address the problem that the concrete must be covered or shielded during setting, and thus is liable to interference and disruption. Furthermore, the wet concrete presents a hazard to pedestrians in the vicinity.

### SUMMARY OF THE INVENTION

It is one aim of the present invention, amongst others, to provide an improved system and/or method thereof and/or address one or more of the problems discussed above, or discussed elsewhere, or to at least provide an alternative system and/or method.

A first aspect provides a mount assembly for mounting a structure thereto, comprising: a mount comprising: a conduit for routing electrical cables therethrough; and a frame surrounding the conduit for supporting a cover.

In one example, a volume is defined between the frame and conduit to allow a hardening substrate to be introduced into the volume.

In one example, the frame is arranged to support the cover over an open surface of the volume or an open surface of the volume and the conduit.

In one example, the conduit comprises a sleeve portion configured to receive a length of pipe.

In one example, the mount assembly comprises the length of pipe, the length of pipe being sized to define the vertical position of the mount.

In one example, the conduit comprises one or more attachment bolt receiving members for receiving attachment bolts therein.

In one example, the mount assembly further comprises a mounting plate configured to be provided atop the conduit.

In one example, the mounting plate is supported on the frame.

In one example, the mounting plate comprises holes for receiving mounting bolts therethrough.

In one example, the mount assembly further comprises a top layer for covering the mounting plate.

In one example, the top layer comprises apertures for receiving mounting bolts therethrough.

In one example, the mount assembly further comprises a set of mounting bolts attachable to the mounting plate to provide a mounting point for the structure.

In one example, the frame is connected to one or more outer surfaces of the conduit.

In one example, the frame comprises a plurality of frame pieces. The plurality of frame pieces may comprise a pair of first frame pieces and a pair of second frame pieces.

In one example, the structure is an electric vehicle charge point, an item of electrified street furniture, a power feeder pillar and/or a telecommunications feeder pillar.

A second aspect provides a method of installing a mount assembly for mounting a structure thereto, comprising, in an installation volume: providing a mount comprising a conduit for routing electrical cables therethrough and a frame surrounding the conduit for supporting a cover.

In an example, the method comprises providing a length of pipe in the installation volume; and receiving the length of pipe in a sleeve portion of the conduit.

In an example, the method comprises sizing the length of pipe to define the vertical position of the mount.

In an example, the method comprises excavating the ground to form an excavation volume as the installation volume.

In an example, the method comprises attaching a mounting plate to the conduit. The method may comprise attaching the mounting plate to the conduit using one or more attachment bolts.

In an example, the method comprises introducing a hardening substrate into a volume defined between the frame and conduit and using the frame to support the cover over an open surface of the volume to cover the hardening substrate.

A third aspect provides an assembly comprising: a structure; and a mount assembly for mounting the structure thereto comprising: a mount comprising: a conduit for routing electrical cables therethrough; and a frame surrounding the conduit for supporting a cover. In an example the structure is an electric vehicle charge point.

A fourth aspect provides a kit of parts comprising: a structure; and a mount assembly for mounting the structure thereto comprising: a mount comprising: a conduit for routing electrical cables therethrough; and a frame surrounding the conduit for supporting a cover. In an example, the structure is an electric vehicle charge point.

A fifth aspect provides a kit of parts comprising: a cover; and a mount assembly for mounting a structure thereto comprising: a mount comprising: a conduit for routing electrical cables therethrough; and a frame surrounding the conduit for supporting the cover. In an example, the structure is an electric vehicle charge point.

It will of course be appreciated that features described in relation to one aspect of the present invention may be incorporated into other aspects of the present invention. For example, the method of any aspect of the invention may incorporate any of the features described with reference to the mount assembly of any aspect of the invention and vice versa. Additionally, for example, the assembly or kit of parts of any aspect of the invention may incorporate any of the features described with reference to the mount assembly and/or method of any aspect of the invention and vice versa.

Other preferred and advantageous features of the invention will be apparent from the following description.

### BRIEF DESCRIPTION OF THE FIGURES

For a better understanding of the invention, and to show how embodiments of the same may be carried into effect, reference will now be made, by way of example only, to the accompanying diagrammatic drawings in which:

FIG. 1 shows a mount assembly;

FIG. 2 shows an exploded view of a mount;

FIG. 3 shows the mount of FIG. 2 in assembled form;

FIG. 4 shows an underside view of the assembled mount of FIG. 3;

FIG. 5 shows an exploded view of a mount assembly;

FIG. 6 shows an installation volume;

FIG. 7 shows a mount located in the installation volume;

FIG. 8 shows general methodology principles;

FIG. 9 shows an assembly;

FIG. 10 shows a kit of parts; and

FIG. 11 shows a kit of parts.

### DETAILED DESCRIPTION OF THE INVENTION

According to the present invention there is provided a system and method as set forth in the appended claims. Other features of the invention will be apparent from the dependent claims, and the description which follows.

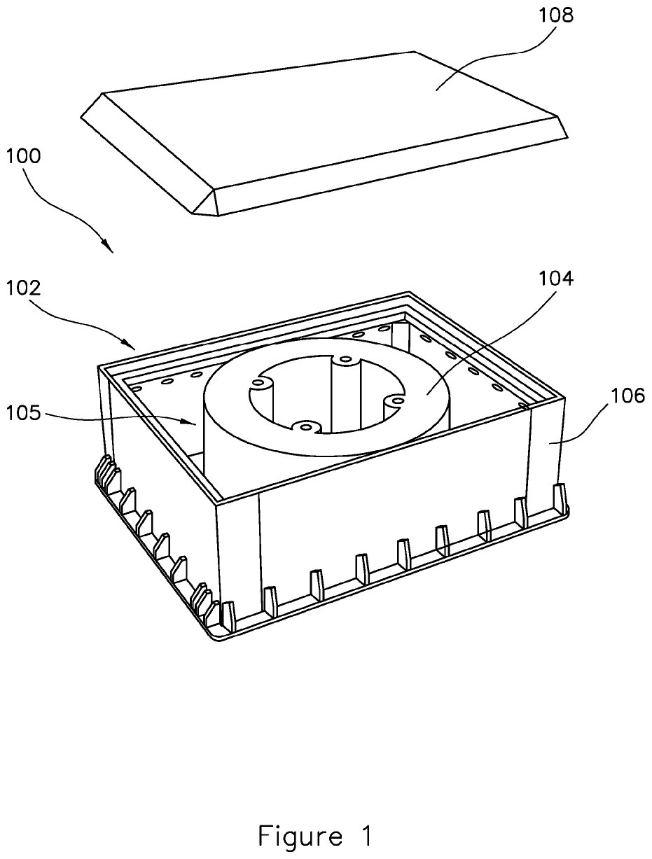

Referring to FIG. 1, a mount assembly 100 is shown. The mount assembly 100 is for mounting a structure (not shown) thereto.

The mount assembly 100 comprises a mount 102. The mount 102 comprises a conduit 104. The conduit 104 is for routing electrical cables therethrough. The mount 102 further comprises a frame 106. The frame 106 surrounds the conduit 104. The frame 106 is for supporting a cover 108.

As will be discussed in greater detail below, during installation a hardening substrate is provided about the conduit 104 so as to secure the mount 102 to the ground. Advantageously, by providing the frame 106 surrounding the conduit 104 for supporting the cover 108, the hardening substrate can be protected by the cover 108 when it is supported on or by the frame 106. Furthermore, the conduit 104, which is open at a top surface to enable access to electrical cables routed therein, can be protected by the cover 108. The cover 108 is removably provided on, and supported by, the frame 106. The cover 108 can be removed to allow the introduction of a hardening substrate into a volume defined between the frame 106 and the conduit 104.

The frame 106 is also advantageous as it can aid measurement of whether the mount assembly 100 is provided level (or horizontal). For example, during installation, the corners of the frame 106 may be used to measure that the mount assembly 100 is provided level. This ensures more accurate level installation as the point of measurement is further away from the centre of gravity of the mount assembly 100. In this way, it may be ensured that the structure is vertical when subsequently installed on the mount assembly 100.

A volume 105 is defined between the frame 106 and conduit 104. The volume 105 may otherwise be referred to as a space or chamber. As will be described in greater detail below, the volume 105 allows a hardening substrate to be introduced into the volume 105. The volume 105 has an open surface, which here is an open upper surface, through which hardening substrate can be introduced into the volume 105.

Advantageously, in this way, the hardening substrate can be retained within the volume 105 so as to secure the mount 102 to the ground. The hardening substrate is protected, or shielded, by the cover 108 when it is supported on or by the frame 106.

In an example, the cover 108 is a standard manhole cover (otherwise referred to as a maintenance hole cover). Where a standard manhole cover is used, the frame 106 may be sized to support or receive a standard manhole cover. It will be appreciated that, in this intended use, the manhole cover does not cover a space or volume into which a person may enter. Rather, the manhole cover may cover the conduit 104 and/or the space or volume 105 between the conduit 104 and the frame 106. Use of a manhole cover is highly advantageous due to widespread availability, standardised sizing, and low cost.

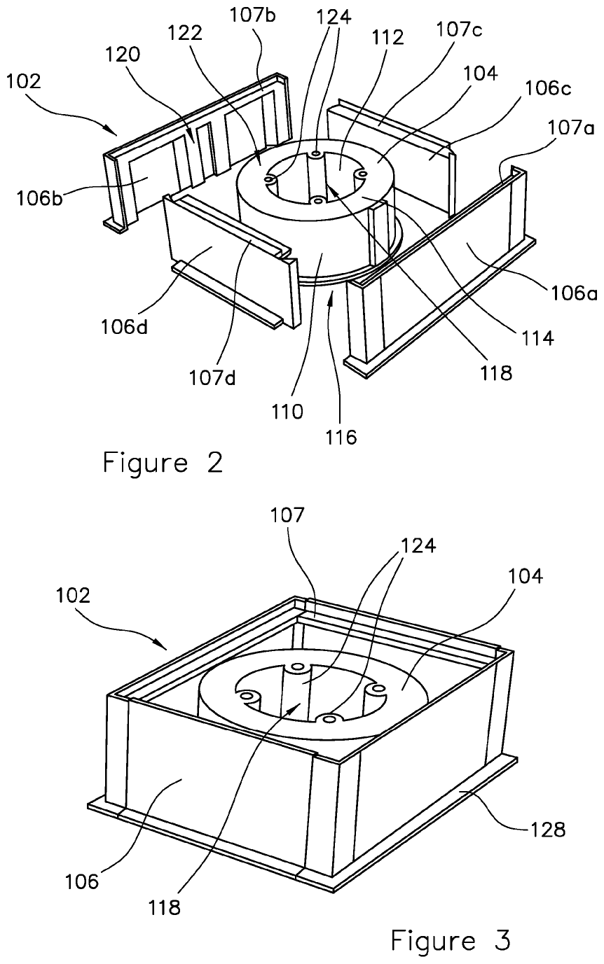

Referring to FIG. 2, the mount 102 is shown in isolation, in an exploded view. The frame 106 comprises a plurality of frame pieces 106a-106d. In this example, the frame 106 comprises a pair of first frame pieces 106a, 106b and a pair of second frame pieces 106c, 106d. The frame 106 has a rectangular profile in assembled form. The first frame pieces 106a, 106b are of equal length and the second frame pieces 106c, 106d are of equal length. In this example, the first frame pieces 106a, 106b each have a length of around 600 mm, and the second frame pieces 106c, 106d each have a length of around 450 mm. The frame pieces 106a-106d are joined at their respective ends. The assembled frame 106 has internal top dimension of 600 mm×450 mm.

The frame 106 being formable from a plurality of frame pieces 106a-106d is beneficial in transportation of the disassembled mount 102, as the frame pieces 106a-106d can be flat-packed. Furthermore, the frame 106 having a rectangular profile in assembled form enables use of a standard manhole cover (otherwise referred to as a maintenance hole cover), with associated benefits of widespread availability, standardised sizing, and low cost.

Each frame piece 106a-106d comprises a cover support arrangement portion 107a-107d. The cover support arrangement portions are in the form of recesses, rebates, or ledges, or may be members which project from the frame 106. The cover support arrangement portions 107a-107d together form a cover support arrangement 107 when the frame 106 is assembled. The cover support arrangement 107 is located proximal to, but below, the upper extent of the frame 106. The cover support arrangement 107 extends horizontally inward in the frame 106. When the cover 108 (or mounting plate, described below) is installed in the mount, the cover 108 (or mounting plate) is supported by, and rests on, the cover support arrangement 107 of the frame 106.

In an example, one or more of the frame pieces 106a-106d may comprise an aperture (not shown) formed in the planar surface thereof. Advantageously, this reduces weight of the frame 106 and reduces manufacturing costs. Furthermore, when during installation a hardening substrate is introduced between the frame 106 and the conduit 104, the hardening substrate may flow through the aperture(s) formed in the frame pieces 106a-106d to improve ground stability. Additionally, or alternatively, a stabilising member such as a scaffolding pole can be passed through the apertures between the sides of the frame 106, thereby to provide additional ground stability. The, or each, aperture may be a square or rectangular aperture.

The conduit 104 has the form of a hollow cylinder. The conduit 104 comprises an outer surface 110, an inner surface 112, a top surface 114 and a bottom surface 116. A channel 118 extends through the conduit 104 between the top surface 114 and the bottom surface 116. The conduit 104 is open at the top surface 114 and bottom surface 116.

The conduit 104 and frame 106 are configured to be connected to, or engage, one another. In this example, the first frame pieces 106a, 106b are configured to connect to the outer surface 110 of the conduit 104 by dovetail joints. A first part 120 of the dovetail joint is provided at each first frame piece 106a, 106b and two second parts 122 of the dovetail joint are provided at the outer surface 110 of the conduit 104. In other examples, the first frame pieces 106a, 106b may be configured to connect to the outer surface 110 of the conduit 104 by other connection means, for example using clips.

Advantageously, by connecting the conduit 104 and the frame 106, a robust mount 102 is provided, and alignment of the conduit 104 and frame 106 can be ensured prior to installation.

As shown in FIG. 1, the volume 105 is defined between one or more outer surfaces of the conduit 104 and one or more inner surfaces of the frame 106. In the specific embodiment shown, the volume 105 is defined between the outer surface (e.g., outer cylindrical surface) of the conduit 104 and the inner surfaces of the frame 106 (e.g., inner surface of a plurality of, or each, frame piece). Whilst a volume 105 is described, the volume 105 may be divided into a plurality of (e.g., two) volume portions, for example due to the connections between the conduit 104 and the frame 106 as illustrated in FIG. 1.

The conduit 104 comprises one or more attachment bolt receiving members 124 in the form of lugs. The lugs 124 are for receiving attachment bolts (not shown) therein, to attach the conduit 104 to a mounting plate (described below). The lugs 124 each have a tubular form, such that the shank of an attachment bolt can extend therethrough. The lugs 124 are provided at or on the inner surface 112 of the conduit 104. When attachment bolts are inserted and received in the lugs 124, a part of the shank of the attachment bolt projects above the top surface 114 of the conduit 104. This allows a mounting plate to be attached at the attachment bolts projecting upwardly from the conduit 104. In an alternative construction, or in combination with the lugs 124 provided at or on the inner surface 112 of the conduit 104, the lugs 124 may be formed as bores extending between the top surface 114 and bottom surface of the conduit 116 to open at said surfaces. Alternatively, the lugs 124 may have a reduced length to the illustrated example. In an example, the lugs 124 may instead be formed as bores extending from the top surface 114 but terminating prior to the bottom surface of the conduit 116, thus having a reduced length. In this way, the length of required attachment bolts may be reduced. In an example, captive nuts (not shown) may be retained within the lugs 124.

It may be desired to provide adjustment means or adjustment elements, to allow minor levelling adjustments to be made to the mounting plate (described below). In an example, the attachment bolts may be provided with washers of appropriate thickness to allow levelling of the mounting plate (described below) when attached to the conduit 104. Other adjustment elements may be provided. For example, height adjustable risers may be provided at the top surface 114 of the conduit 104.

In this example, the conduit 104 comprises four lugs 124. The lugs 124 are equally spaced about the inner surface 112.

Referring to FIG. 3, the mount 102 is shown in isolation, and in assembled form. The conduit 104 and frame 106 are connected to one another. This is achieved by virtue of the above described dovetail joints. The cover supporting arrangement 107 is also shown in FIG. 3, as a continuous ledge extending horizontally inward in the frame.

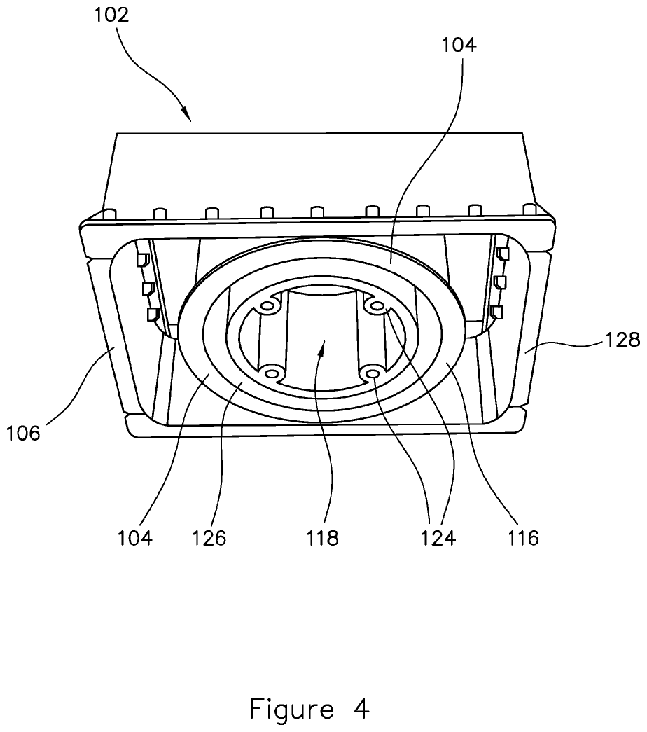

Referring to FIG. 4, an underside (i.e., bottom) view of the assembled mount 102 is shown. The conduit 104 comprises a sleeve portion 126. The sleeve portion 126 is configured to receive a length of pipe. An end region of the pipe is insertable into the sleeve portion 126. The sleeve portion 126 is provided at the bottom surface 116 of the conduit 104.

The length of pipe is for housing electrical cables, and thus, by the present construction, a housed or shielded path for the electrical cables is provided from the length of pipe to, and through, the conduit 104.

The frame 106 comprises a flange 128 extending outwardly from the frame 106. The flange 128 extends from a lower edge of the frame 106. The flange 128 extends around the entire outer profile of the frame 106, but may alternatively be provided in parts, or only at certain frame pieces. Advantageously, when the mount 102 is set in concrete, the flange 128 provides an anchor which prevents, or increases the difficulty of, the mount 102 being pulled upwardly from the concrete. However, in some examples, the frame 106 may be absent the flange 128. This may advantageously enable stacking of multiple mounts 102 and/or frames 106 on top of one another, to facilitate installation of the mount assembly 100 in deep installation volumes.

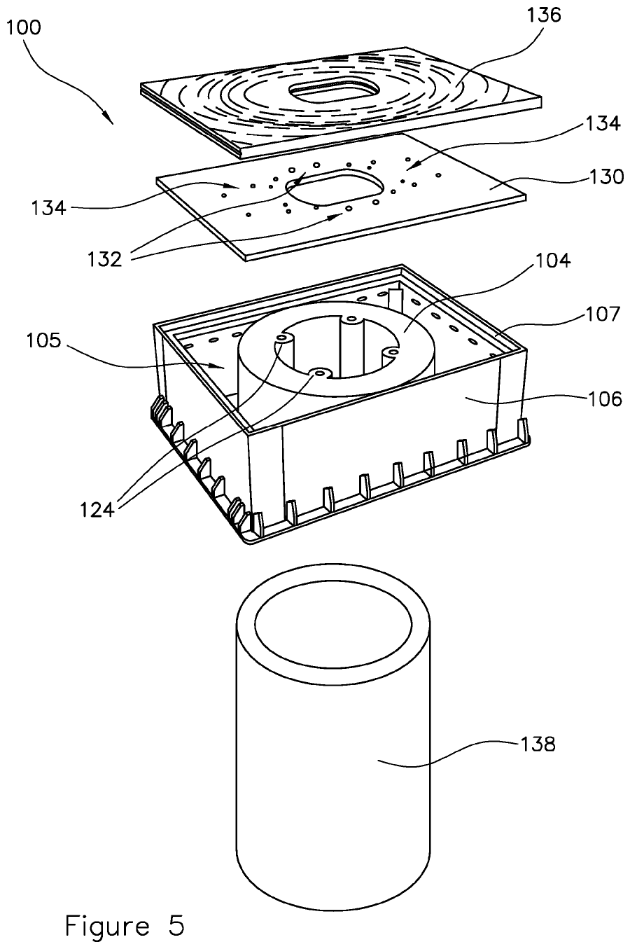

Referring to FIG. 5, the mount assembly 100 is shown, with the cover 108 absent.

The mount assembly 100 comprises a mounting plate 130. The mounting plate 130 is configured to be provided atop (i.e. on top of) the conduit 104. In this way, the mounting plate 130 facilitates mounting of the structure to the mount assembly 100 via the mounting plate 130.

The mounting plate 130 is configured to be supported on the frame 106. In this way, a strong and robust mounting is provided for. In this example, the mounting plate 130 is provided on, and supported by, the cover support arrangement 107 of the frame 106. In this example, the mounting plate 130 is formed of metal.

The mounting plate 130 comprises apertures 132 for receiving attachment bolts (as described above) therethrough. In this way, the mounting plate 130 may be attached to the conduit 104 by virtue of the attachment bolts. The apertures 132 are aligned with the attachment bolt receiving members 124 of the conduit 104 when the mounting plate 130 is positioned on the frame 106.

The mounting plate 130 further comprises one or more sets of holes 134. Each set of holes 134 may correspond with holes in a base or stanchion of a particular type or make of structure. In this way, a single mounting plate 130 may be suitable for mounting different types or makes of structure thereon.

The mounting plate 130 may be formed of metal, and in particular may be a pressed or stamped metal sheet. The mounting plate 130 may be formed of aluminium, which may be machined aluminium. Alternatively, the mounting plate 130 may be formed of stainless steel or galvanised steel. Advantageously, the mounting plate 130 being formed of stainless steel or galvanised steel reduces manufacturing costs compared with machined aluminium.

The mount assembly 100 comprises a top layer 136. The top layer 136 is for covering the mounting plate 130. The top layer 136 is to be provided over the mounting plate 130. The top layer 136 may thus be a layer which is provided at ground level. The top layer 136 may be formed of plastic and comprise an anti-slip pattern, improving pedestrian safety.

The top layer 136 may be provided with apertures for receiving bolts therethrough. In this way, the top layer 136 may be connected to the mounting plate 130.

The top layer 136 may comprise a plurality of clips. The clips may be provided along the long edges of the top layer 136. The clips are arranged to engage corresponding apertures provided at the upper edges of the frame 106. In this way, deformation (e.g., flaring) of the top layer 136 may be prevented or reduced.

The mount assembly 100 comprises a length of pipe 138, as described above, to be received in the sleeve portion 126 of the conduit 104. The length of pipe 138 extends vertically to the conduit 104. The length of pipe 138 may be sized to define the vertical position of the mount 102. That is, a shorter length of pipe 138 may be suitable for shallower ground installations, whereas a longer length of pipe 138 may be suitable for deeper ground installations, in each case the mount 102 being positioned flush with the ground surface. This is advantageous as the mount 102 need not be modified for different depth installations. Instead, the length of pipe 138 can be sized to position the mount 102, which simplifies installation.

In another example (not shown), the frame and conduit may be a single unit, for example integrally formed. This might offer a simple constructions and installation approach. However, the examples described in more detail above (e.g. where the frame and conduit are at least initially separate, and/or the frame is formed of pieces) may offer greater construction and installation freedoms and options.

In relation to the above, it will be appreciated that the mount assembly 100 is for sub-surface, or below-ground, installation. This will be further understood from the below, in particular with reference to the provision of the mount assembly 100 in installation volume 200.

A method of installing the mount assembly 100 will be described with reference to FIGS. 5-7.

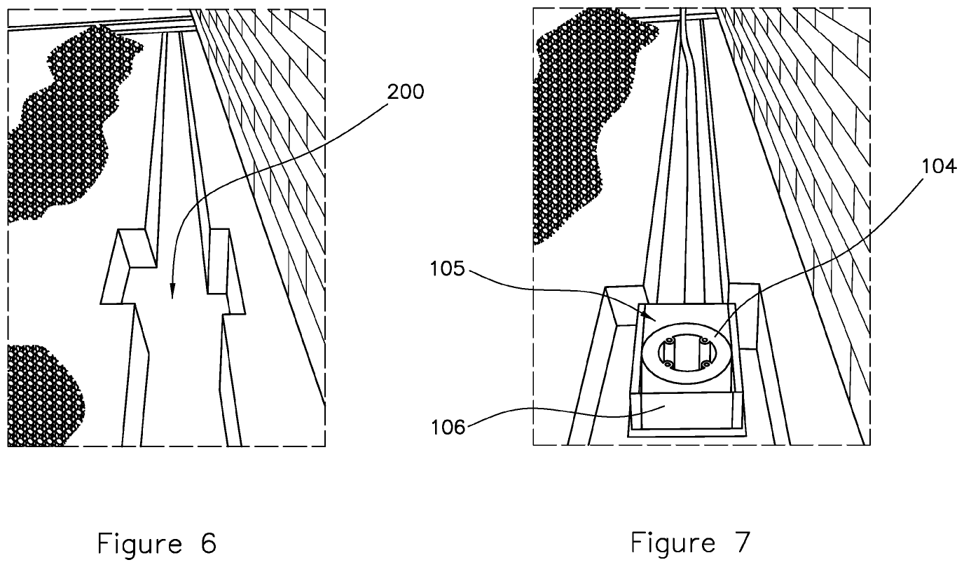

An installation volume 200 is shown in FIG. 6. The installation volume 200 may be provided by excavating the ground to form an excavation volume as the installation volume. This may be preceded by blacktop (asphalt) removal. Electrical cables (housed in conduit) may be laid in the installation volume 200.

The required depth of the installation volume 200 depends electrical installation standards for specific scenarios. For example, a depth of 750 mm is required for electrical installation in highways or roads, a depth of 600 mm is required for electrical installation in pavements, and a depth of 450 mm is required for electrical installation in private land.

The length of pipe 138 is sized appropriate to the depth of the installation volume 200. For example, the length of pipe 138 may be cut shorter where a shallower installation volume 200 is required or cut longer where a deeper installation volume 200 is required. In an example, the pipe 138 is a solid unperforated 300 mm internal diameter twin-wall pipe.

The mount 102 is then provided on the length of pipe 138 by inserting the length of pipe into the sleeve portion 126 of the conduit 104. The position of the mount 102 can be adjusted relative to the length of pipe 138 to ensure the mount is horizontal and to provide the mount 102 flush with ground level. The frame 106 may be used (as a point away from the centre of gravity) to measure that the mount assembly 100 is level. At this point, the conduit 104 is attached to the length of pipe 138. In this example, the conduit 104 is attached to the length of pipe 138 using screws extending horizontally from the outer surface 110 of the conduit 104 and through the sleeve portion 126 where the length of pipe 138 is received. Alternatively, a suitable adhesive may be used.

In some examples, in addition to using the length of pipe 138, or as an alternative, multiple mounts 102 may be stacked on top of one another. This is advantageous in installation deeper installation volumes 200. A mount assembly 100 comprising multiple mounts 102 may thereby be provided.

A hardening substrate is then used to secure the mount 102 in place. The hardening substrate is introduced into the volume 105 defined between the frame 106 and conduit 104. The hardening substrate is also introduced around the outside of the frame 106. In this example, the hardening substrate is concrete. The hardening substrate is functionally something that can introduced into the volume, and then harden, to form a substrate. Typically, the hardening substrate will be introduced into the volume in an initially fluid or flexible form, and will (over time) set to form a more rigid, hardened, substrate.

The cover 108 is then placed on the frame 106 to be supported thereon. The cover 108 may extend between the frame 106 and over the conduit 104, thus protecting the hardening substrate until it sets. Furthermore, the cover 108 may be of a size or configuration such that when it is supported by the frame 106 it extends over the volume 105 and also the setting hardening substrate outside of the frame 106. The hardening substrate can be left unattended to set, as the hardening substrate is protected by the cover 108.

At a later time, it may be desired to install or mount a structure in place.

The structure may be an electric vehicle charge point. Advantageously, electric vehicle charge points are typically in high foot-traffic areas, and thus using the mount assembly 100 is beneficial as the hardening substrate is protected whilst it sets, and also the cover 108 mitigates any trip hazard from protruding or projecting elements from the ground. Alternatively, the structure may be an item of electrified street furniture, a power feeder pillar and/or a telecommunications feeder pillar. All such structure can be provided with electrical connection via the cables routed through the length of pipe 138 and conduit 104.

When installing the structure, the cover 108 is first removed. Advantageously, the cover 108 can be reused at a different site or installation. The electrical cables are pulled through the channel 118 in the conduit 104 ready for electrical connection to the structure.

The one or more sets of holes 134 provided in the mounting plate 130 are used as a template to form appropriate holes in the top layer 136. A set of holes 134 appropriate for the base or stanchion of the structure to be installed is selected, and corresponding holes are drilled in the top layer 136. A set of one or more mounting bolts (not shown) are inserted upwardly through the appropriate set of holes 134 in the mounting plate 130, and nuts used to secure the bolts in place to attach the mounting bolts to the mounting plate 130. The mounting bolts project beyond the nuts such that a length of the shank of the bolt is free, to allow the base of the structure to be mounted thereon.

The mounting plate 130 is then attached to the mount 102. The mounting plate 130 is placed onto the frame 106 and supported by the cover support arrangement 107. Attachment bolts are inserted through the apertures 132 of the mounting plate 130 and into and through the lugs 124 of the conduit 104. As described above, adjustment elements may be included to allow levelling adjustments to be made to the mounting plate 130. For example, washers of appropriate thickness may be provided at the top surface 114 of the conduit 104, to level the mounting plate 130. Additionally, or alternatively, height adjustable risers may be used to level the mounting plate 130. Nuts are tightened onto the inserts bolts to secure the mounting plate 130 to the conduit 104 and thus the mount 102.

The top cover 136 is placed over the mounting plate 130. In this arrangement, the mounting bolts project from the upper surface of the top cover 136 by virtue of extending through the corresponding holes previously drilled in the top layer 136.

The structure is then positioned on the top layer 136, with the mounting bolts extending through apertures in the base of the structure. Nuts are tightened onto the mounting bolts to secure the structure to the mount assembly 100.

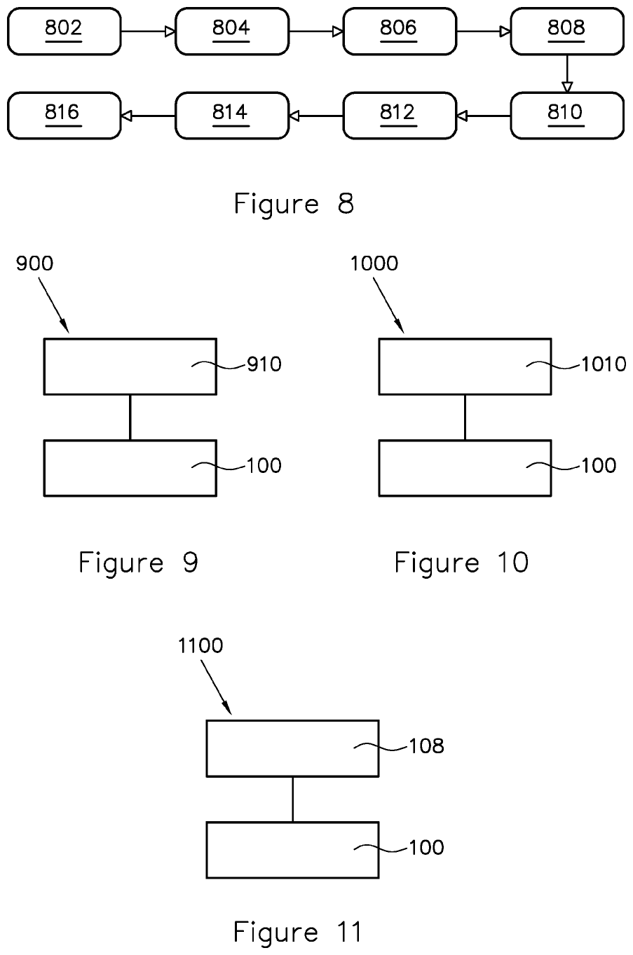

Referring to FIG. 8, a method of installing a mount assembly 100 for mounting a structure thereto is shown. The method may comprise any or all of the method steps described above. A necessary or desired order of steps in the method will be apparent to those skilled in the art.

The method takes place generally in an installation volume. That is, the mount assembly 100 is to be provided, or located, in an installation volume. This may be any suitable volume, but is typically below ground level.

Step 802 comprises providing a mount 102 comprising a conduit 104 for routing electrical cables therethrough and a frame 106 surrounding the conduit 104 for supporting a cover 108.

Advantageously, by providing the frame 106 surrounding the conduit 104 for supporting the cover 108, the hardening substrate can be protected by the cover 108 when it is supported on or by the frame 106. Furthermore, the conduit 104, which is open at a top surface to enable access to electrical cables routed therein, can be protected by the cover 108.

Step 804 comprises providing a length of pipe 138 in the installation volume. Step 806 comprises receiving the length of pipe 138 in a sleeve portion of the conduit 104.

In this way, a housed or shielded path for electrical cables is provided from the length of pipe to the conduit 104. Furthermore, a continuous path is thus provided, ensuring protection of the electrical cables.

Step 808 comprises sizing the length of pipe 138 to define the vertical position of the mount 102.

In this way, the mount 102 need not be modified for different depth installations. Instead, the length of pipe 138 can be sized to position the mount 102, which simplifies installation.

Step 810 comprises excavating the ground to form an excavation volume as the installation volume 200.

In this way, the mount assembly 100 can be located in the ground.

Step 812 comprises attaching a mounting plate 130 to the conduit 104. Step 814 comprises attaching the mounting plate 130 to the conduit 104 using one or more bolts.

In this way, the mounting plate 130 facilitates mounting of the structure to the mount assembly 100 via the mounting plate 130.

Step 816 comprises introducing a hardening substrate into a volume 108 defined between the frame 106 and conduit 104 and using the frame 106 to support the cover 108 over an open surface of the volume 108 to cover the hardening substrate.

Advantageously, in this way, the hardening substrate can be retained within the volume 108 so as to secure the mount 102 to the ground. The hardening substrate is protected, or shielded, by the cover 108 when it is supported on or by the frame 106.

Referring to FIG. 9, an assembly 900 is shown. The assembly 900 comprises a structure 910. The assembly further comprises a mount assembly 100 for mounting the structure 910 thereto. The mount assembly 100 comprises a mount 102. The mount 102 comprises a conduit 104 for routing electrical cables therethrough and a frame 106 surrounding the conduit for supporting a cover 108. The structure 910 may be an electric vehicle charge point, an item of electrified street furniture, a power feeder pillar and/or a telecommunications feeder pillar.

Referring to FIG. 10, a kit of parts 1000 is shown. The kit of parts 1000 comprises a structure 1010. The kit of parts further comprises a mount assembly 100 for mounting the structure 1010 thereto. The mount assembly 100 comprises a mount 102. The mount 102 comprises a conduit 104 for routing electrical cables therethrough and a frame 106 surrounding the conduit for supporting a cover 108. The structure 1010 may be an electric vehicle charge point, an item of electrified street furniture, a power feeder pillar and/or a telecommunications feeder pillar.

Referring to FIG. 11, a kit of parts 1100 is shown. The kit of parts 1100 comprises a cover 108. In an example, the cover 108 is a manhole (or maintenance hole) cover. The kit of parts 1100 further comprises a mount assembly 100 for mounting a structure thereto. The mount assembly 100 comprises a mount 102. The mount 102 comprises a conduit 104 for routing electrical cables therethrough and a frame 106 surrounding the conduit for supporting the cover 108. The structure may be an electric vehicle charge point, an item of electrified street furniture, a power feeder pillar and/or a telecommunications feeder pillar.

### Definitions

Although a preferred embodiment has been shown and described, it will be appreciated by those skilled in the art that various changes and modifications might be made without departing from the scope of the invention, as defined in the appended claims and as described above.

Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A mount assembly for mounting a structure thereto, comprising:
a mount comprising:
a conduit for routing electrical cables therethrough; and
a frame surrounding the conduit for supporting a cover.

2. The mount assembly according to claim 1, wherein a volume is defined between the frame and conduit to allow a hardening substrate to be introduced into the volume.

3. The mount assembly according to claim 2, wherein the frame is arranged to support the cover over an open surface of the volume or an open surface of the volume and the conduit.

4. The mount assembly according to claim 1, wherein the conduit comprises a sleeve portion configured to receive a length of pipe.

5. The mount assembly according to claim 4, wherein the mount assembly comprises the length of pipe, the length of pipe being sized to define the vertical position of the mount.

6. The mount assembly according to claim 1, wherein the conduit comprises one or more attachment bolt receiving members for receiving attachment bolts therein.

7. The mount assembly according to claim 1, further comprising a mounting plate configured to be provided atop the conduit.

8. The mount assembly according to claim 7, wherein the mounting plate is supported on the frame.

9. The mount assembly according to claim 7, wherein the mounting plate comprises holes for receiving mounting bolts therethrough.

10. The mount assembly according to claim 7, further comprising a top layer for covering the mounting plate.

11. The mount assembly according to claim 10, wherein the top layer comprises apertures for receiving mounting bolts therethrough.

12. The mount assembly according to claim 7, further comprising a set of mounting bolts attachable to the mounting plate to provide a mounting point for the structure.

13. The mount assembly according to claim 1, wherein the frame is connected to one or more outer surfaces of the conduit.

14. The mount assembly according to claim 1, wherein the frame comprises one or more of: a plurality of frame pieces, or a pair of first frame pieces and a pair of second frame pieces.

15. The mount assembly according to claim 1, wherein the structure is one or more of an electric vehicle charge point, an item of electrified street furniture, a power feeder pillar, and a telecommunications feeder pillar.

16. A method of installing a mount assembly for mounting a structure thereto, comprising, in an installation volume:
providing a mount comprising a conduit for routing electrical cables therethrough and a frame surrounding the conduit for supporting a cover.

17. The method according to claim 16, comprising:
providing a length of pipe in the installation volume; and
receiving the length of pipe in a sleeve portion of the conduit.

18. The method according to claim 17, comprising:
sizing the length of pipe to define the vertical position of the mount.

19. The method according to claim 16, comprising:
excavating the ground to form an excavation volume as the installation volume.

20. The method according to claim 16, comprising one or both of:
attaching a mounting plate to the conduit; or
attaching the mounting plate to the conduit using one or more attachment bolts.

21. The method according to claim 16, comprising:
introducing a hardening substrate into a volume defined between the frame and conduit and using the frame to support the cover over an open surface of the volume to cover the hardening substrate.

22. An assembly comprising:
the mount assembly of claim 1; and
the structure;
wherein the structure is an electric vehicle charge point.

23. A kit of parts comprising:
the mount assembly of claim 1; and
the structure;
wherein the structure is an electric vehicle charge point.

24. A kit of parts comprising:
the mount assembly of claim 1; and
the cover;
wherein the structure is an electric vehicle charge point.
